(19) United States
(12) Patent Application Publication
(10) Pub. No.: US 2007/0089840 A1
(43) Pub. Date: Apr. 26, 2007

(54) Slat tilting device for a window covering

(76) Inventor: Tai-Long Huang, Changhua (TW)

Correspondence Address: JACOBSON HLOMAN PLLC, 400 SEVENTH STREET, N.W., WASHINGTON, DC, 20004, US

(21) Appl. No.: 11/256,977

(22) Filed: Oct. 25, 2005

(51) Int. Cl. E06B 9/307

(52) U.S. Cl. 160/177 R

(57) ABSTRACT

A slat tilting device for tilting slats of a window covering includes a mounting seat having a horizontal surface and a bearing wall for rotatably supporting a journal segment about a first rotating axis that extends rearwardly and downwardly toward the horizontal surface. The journal segment is connected to a driving shaft and a pulley roller. A driven wheel is rotated by the driving shaft so as to drive a tilt shaft to turn, thereby tilting the slats. An operating cord is wound on the pulley roller, and has two pulled segments that extend downwardly and that are pulled to result in rotation of the pulley roller so as to enable the driving shaft to turn the tilt shaft. A joined gripped end of the operating cord is disposed forwardly and away from the slats to avoid hindrance caused by the slats during the pulling operation.

### BACKGROUND OF THE INVENTION

1. Field of the Invention

This invention relates to a slat tilting device for a window covering, more particularly to a slat tilting device which can be easily operated to tilt slats of the window covering.

2. Description of the Related Art

Referring to FIGS. 1 to 3, in U.S. Pat. No. RE 37143 E, entitled “Slat Angle Adjusting Device For a Venetian Blind,” there is disclosed a Venetian blind 10 which includes a header rail 11, a plurality of slats 121 disposed beneath the header rail 11 and connected to one another by a connecting cord that includes front and rear cord segments 122,123, a tilt shaft 14 turnable relative to the header rail 11 to pull either the front or rear cord segment 122,123 to thereby tilt the slats, and a tilt angle adjusting device 20. The tilt angle adjusting device 20 includes a support bracket 21 which is mounted within the header rail 11, a roller 23 which is rotatably received in the support bracket 21 and which is fixedly mounted around a drive axle 241 formed on a drive gear 24, a worm 26 which is rotatably mounted between two casing halves 281 and which has a driven gear 25 that meshes with the drive gear 24, a pinion 27 which is rotatably mounted between the casing halves 281 and which meshes with the worm 26, and a tilt cord 22 which is wound on the roller 23 and which has right and left pulled segments 221,222 extending downwardly. In operation, a user can exert a pulling force on the right or left pulled segment 221,222 to rotate the roller 23, which can force the drive axle 241 to rotate the drive gear 24, which in turn rotates the driven gear 25 together with the worm 26 about an axis (II), thereby enabling the pinion 27 to rotate about an axis (I) that is perpendicular to the axis (II) so as to turn the tilt shaft 14 for tilting the slats 121.

Since the axis (I) is perpendicular to the axis (II), the right and left pulled segment 221,222 are in close proximity to the slats 121, thereby resulting in inconvenient operation to the user. In addition, the drive gear 24 is coupled with the roller 23 through the non-circular drive axle 241, which tends to wear at the engagement between the roller 23 and the drive axle 241, thereby resulting in malfunctioning. Besides, many component parts are needed to transmit the rotational force of the roller 23 to the tilt shaft 14, thereby resulting in high costs and reduced transmission efficiency.

### SUMMARY OF THE INVENTION

The object of the present invention is to provide a slat tilting device for a window covering which is easy and convenient to operate which has an enhanced force transmission efficiency, and which has a less number of component parts.

According to this invention, the slat tilting device is adapted for a window covering which includes a header rail extending in a longitudinal direction, a plurality of slats disposed beneath the header rail and connected to one another in an upright direction perpendicular to the longitudinal direction by a connecting cord that includes front and rear cord segments respectively disposed forwardly and rearwardly of the slats, and a tilt shaft that is mounted on the header rail and that is turnable relative thereto about a turning axis in the longitudinal direction so as to pull either the front or rear cord segment to thereby tilt the slats.

The device includes a mounting seat having a base wall and a bearing wall. The base wall is adapted to be fixedly mounted on the header rail, and has a horizontal surface which extends in the longitudinal direction and which has front and rear end regions opposite to each other in a transverse direction perpendicular to the upright and longitudinal directions, and a middle region disposed between the front and rear end regions. The front end region has left and right holes extending through the base wall in the upright direction. The bearing wall extends from the middle region in the upright direction to terminate at a bearing surface. An operating unit includes a journal segment, a driving shaft, and a pulley roller. The journal segment is journalled on the bearing surface to be rotatable about a first rotating axis, and has rear and front ends connected to the driving shaft and the pulley roller. The driving shaft extends along the first rotating axis that extends rearwardly and downwardly toward the horizontal surface. A driven wheel is driven by the driving shaft to rotate about a second rotating axis, and is adapted to be connected to the tilt shaft so as to align the second rotating axis with the turning axis for turning the tilt shaft, thereby pulling the front or rear cord segment for tilting the slats. An operating cord is wound on the pulley roller, and is adapted to be disposed forwardly of the slats. The operating cord has left and right pulled segments which extend downwardly and respectively through the left and right holes to terminate at a joined gripped end for manual operation such that pulling of either the left or right pulled segment results in rotation of the pulley roller about the first rotating axis so as to enable the driving shaft to turn the tilt shaft, and such that when the left and right pulled segments stand still, the joined gripped end is disposed forwardly and away from the slats so as to avoid hindrance caused by the slats during the pulling operation of the operating cord.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional Venetian blind;

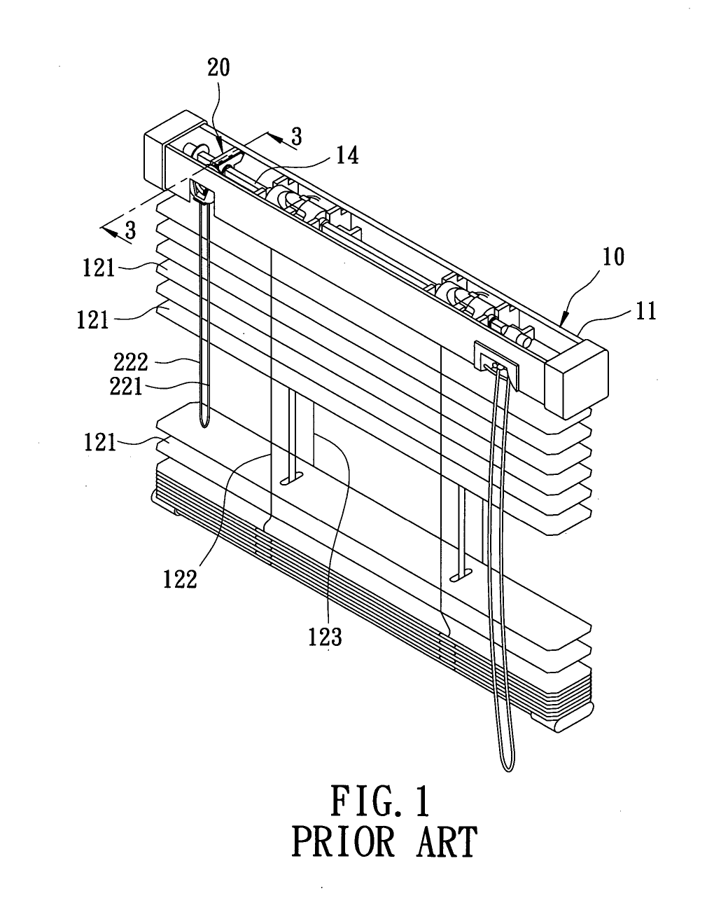

FIG. 2 is an exploded perspective view of a slat angle adjusting device of the conventional Venetian blind;

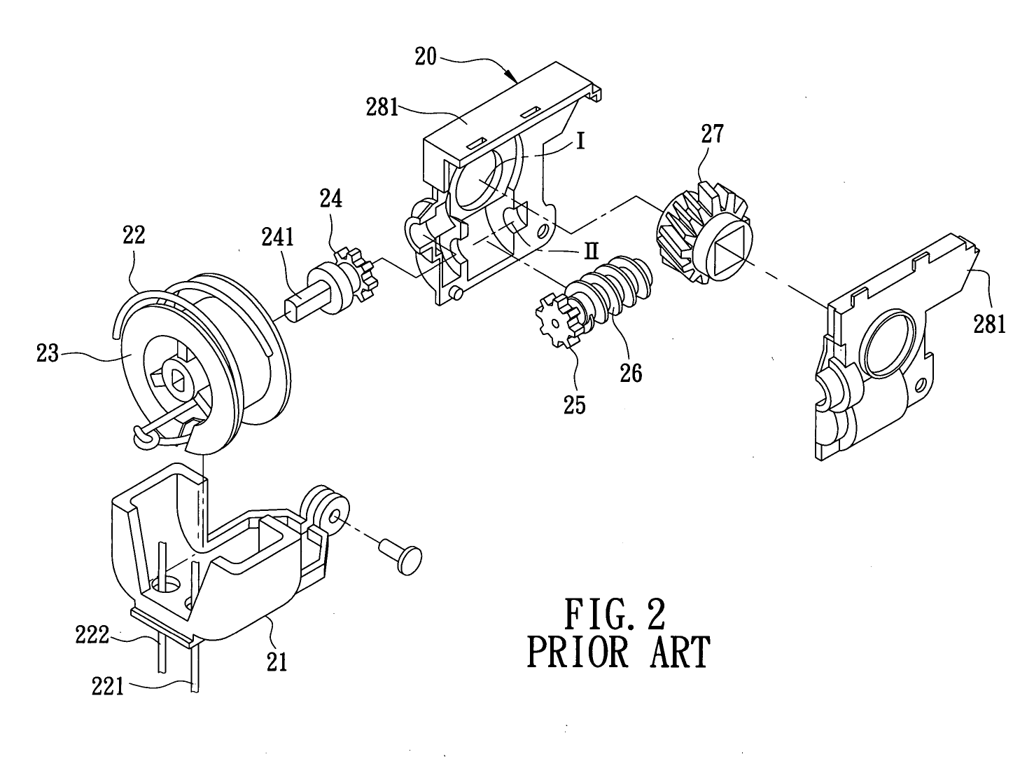

FIG. 3 is a sectional view of the slat angle adjusting device taken along lines 3-3 of FIG. 1;

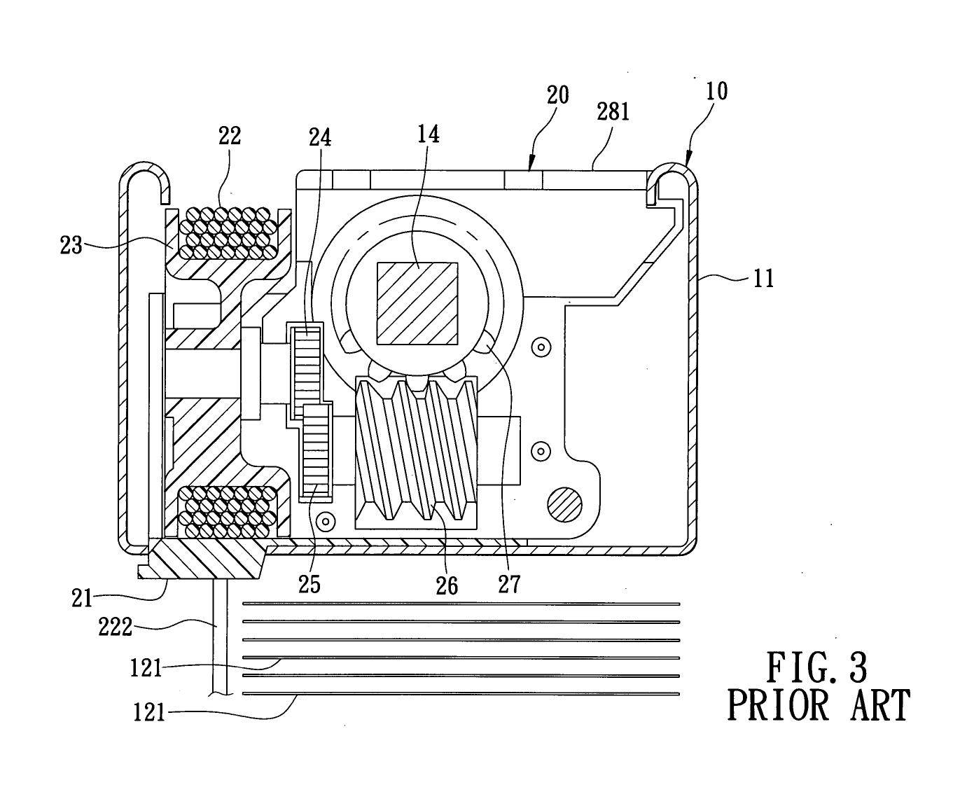

FIG. 4 is a perspective view of the preferred embodiment of a slat tilting device according to this invention when incorporated in a Venetian blind;

FIG. 5 is an exploded perspective view of the preferred embodiment;

FIG. 6 is a perspective view of the preferred embodiment; and

FIG. 7 is a sectional view of the preferred embodiment taken along lines 7-7 of FIG. 4.

### DETAILED DESCRIPTION OF THE PREFERRED EMBODIMENT

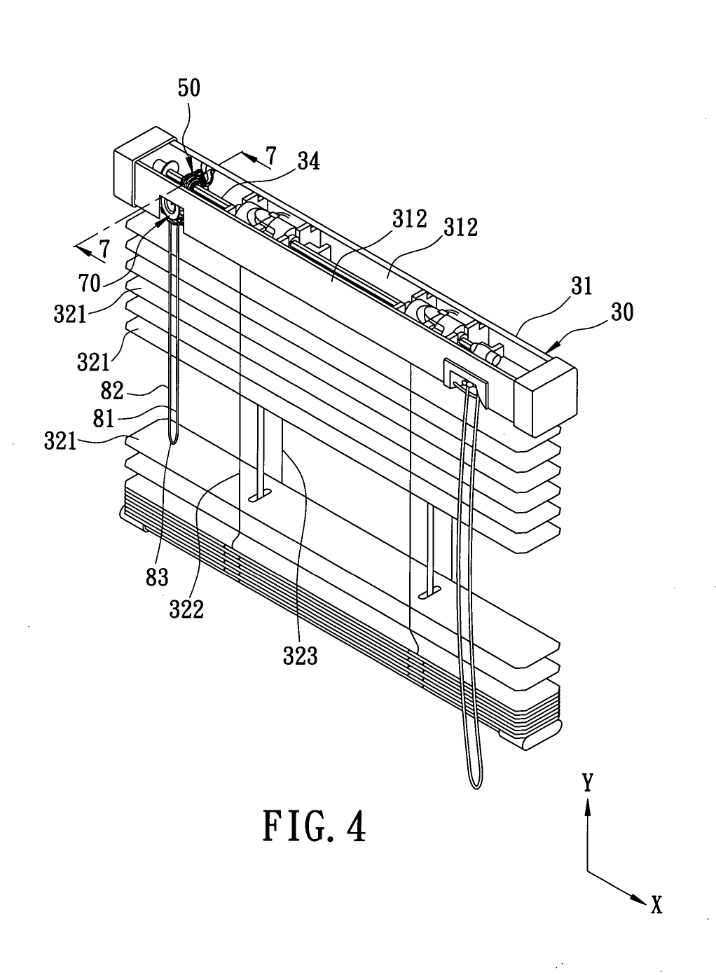

Referring to FIG. 4, the preferred embodiment of a slat tilting device according to the present invention is shown to be mounted on a header rail 31 of a Venetian blind 30. The Venetian blind 30 includes the header rail 31, which extends in a longitudinal direction (X), a plurality of slats 321 disposed beneath the header rail 31 and connected to one another in an upright direction (Y) perpendicular to the longitudinal direction (X) by a connecting cord that includes front and rear cord segments 322,323 that are respectively disposed forwardly and rearwardly of the slats 321, and a tilt shaft 34 which is mounted on the header rail 31 and which is turnable relative thereto about a turning axis in the longitudinal direction (X) so as to pull either the front or rear cord segment 322,323 to thereby tilt the slats 321.

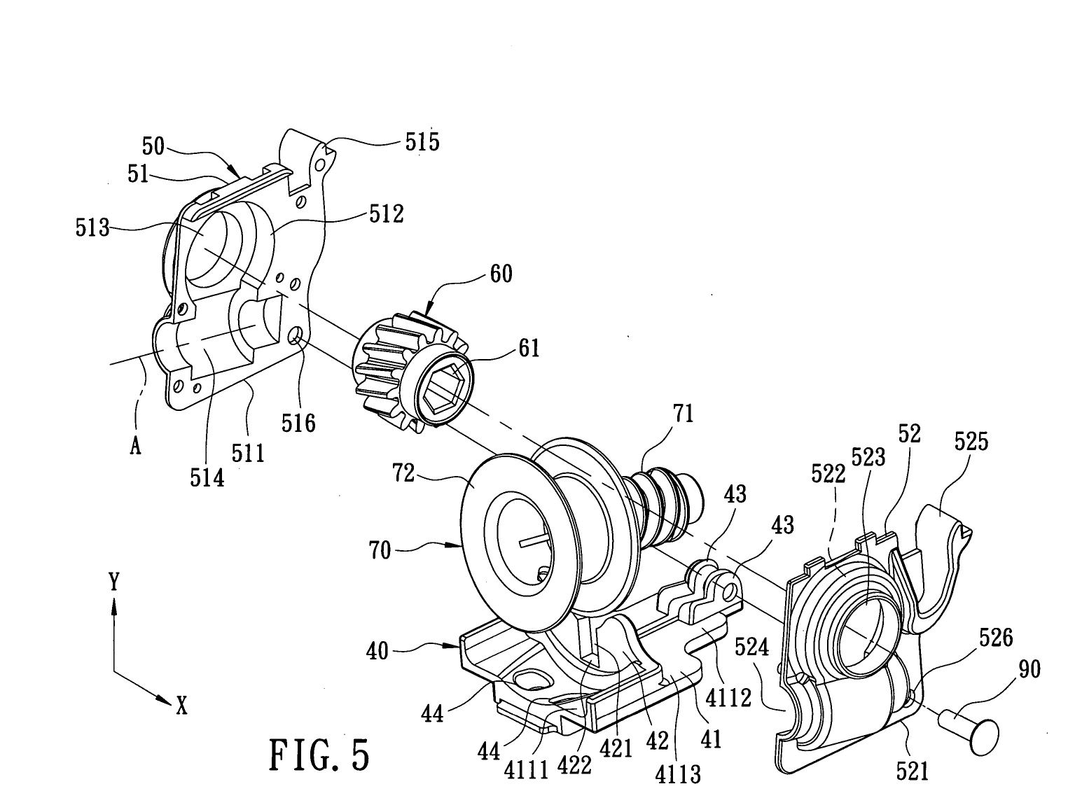

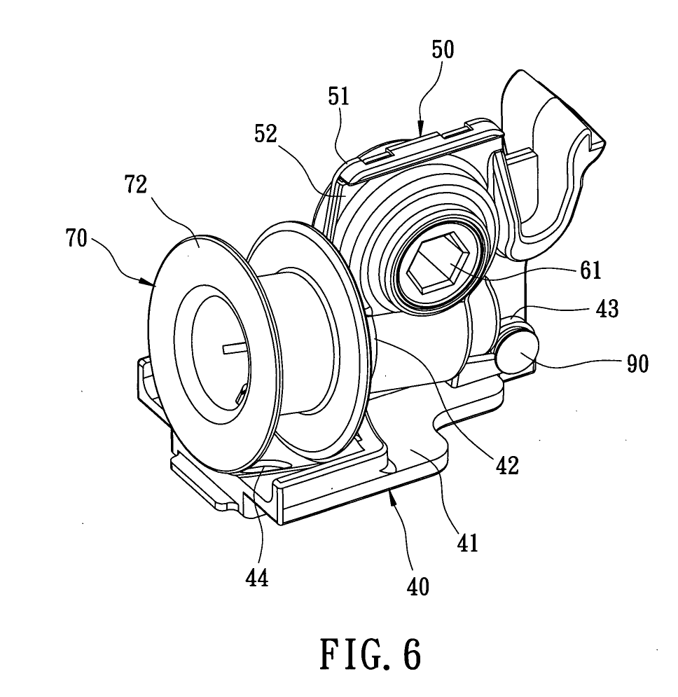

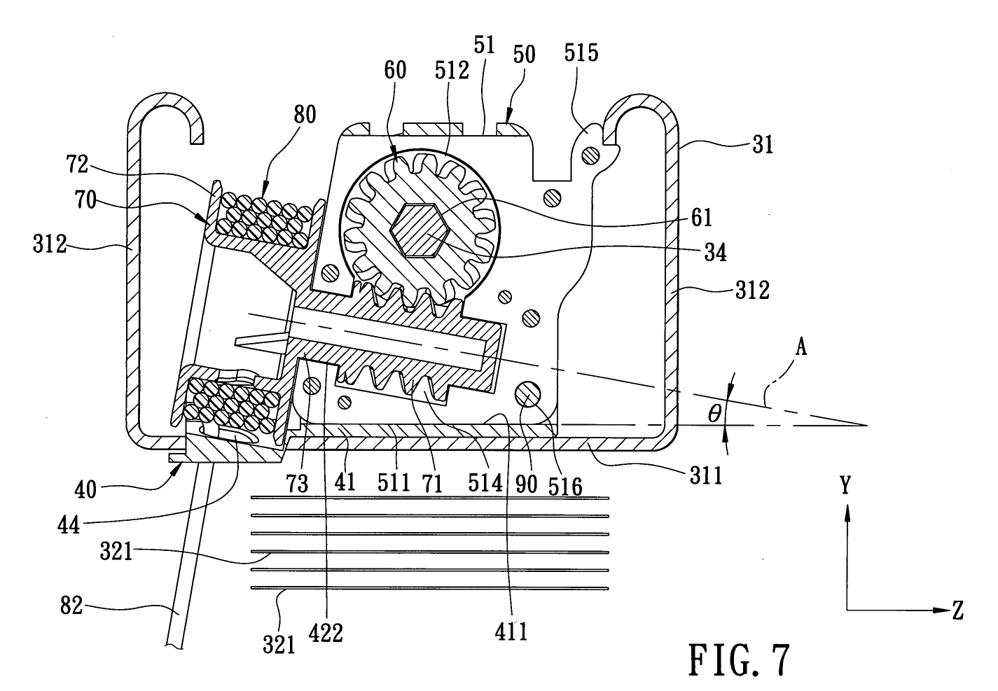

With reference to FIGS. 4 to 7, the slat tilting device is shown to comprise a mounting seat 40, a shell 50, an operating unit 70, a driven wheel 60, and an operating cord 80.

The mounting seat 40 includes a base wall 41 which is adapted to be fixedly mounted on a bottom plate 311 of the header rail 31, and which has a horizontal surface 411 that extends in the longitudinal direction (X) and that has front and rear end regions 4111,4112 opposite to each other in a transverse direction (Z) perpendicular to the upright and longitudinal directions (Y,X), and a middle region 4113 disposed between the front and rear end regions 4111,4112. The front end region 4111 has left and right holes 44 which extend through the base wall 41 in the upright direction (Y). A bearing wall 42 extends from the middle region 4113 in the upright direction (Y), and has an upwardly opening slot 421 which extends downwardly to terminate at a bearing surface 422. Two lugs 43 extends from the rear end region 4112 in the upright direction (Y).

The shell 50 includes left and right shell halves 51,52 which are spaced apart from each other in the longitudinal direction (X) and which extend from the base wall 41 in the upright direction (Y). The left and right shell halves 51,52 respectively have bottom portions 511,521 which are mounted on the base wall 41, and left and right concavity halves 512,522 which extend in the longitudinal direction (X) to cooperatively receive the driven wheel 60, left and right slot halves 514,524 which cooperatively receive a driving shaft 71 of the operating unit 70, left and right through holes 513,523 which are communicated with the left and right concavity halves 512,522, respectively, left and right engaging portions 515,525 which are retained on a side plate 312 of the header rail 31, and left and right locking holes 516,526 which extend in the longitudinal direction.

The operating unit 70 has an integrally formed construction, and includes the driving shaft 71, a pulley roller 72, and a narrow journal segment 73 which is integrally formed between the driving shaft 71 and the pulley roller 72. The journal segment 73 is journalled on the bearing surface 422 to be rotatable about a first rotating axis (A), and has front and rear ends opposite to each other in the transverse direction. The driving shaft 71 is connected to the rear end of the journal segment 73, and extends along the first rotating axis (A), which extends rearwardly and downwardly to intersect the horizontal surface 411 and form an included angle (θ) ranging from about 10 degrees to about 20 degrees therewith. The pulley roller 72 is connected to the front end of the journal segment 73, and is rotatable coaxially with the driving shaft 71 about the first rotating axis (A). In this embodiment, the driving shaft 71 is in the form of a worm.

The driven wheel 60 is in the form of a worm gear, and meshes with the driving shaft 71 to be driven by the driving shaft 71 to rotate about a second rotating axis. The driven wheel 60 has a non-circular hole 61 which is adapted to engage the tilt shaft 34 so as to align the second rotating axis with the turning axis to drive the tilt shaft 34 to turn about the turning axis, thereby pulling the front or rear cord segment 322,323 of the connecting cord for tilting the slats 321 in the same manner as that in prior art.

The operating cord 80 is wound on the pulley roller 72 about the first rotating axis (A), and is disposed forwardly of the slats 321. The operating cord 80 has left and right pulled segments 82,81 which extend downwardly through the left and right holes 44, respectively, to terminate at a joined gripped end 83 for manual operation such that pulling of either the left or right pulled segment 82,81 results in rotation of the pulley roller 72 about the first rotating axis (A), thereby enabling the driving shaft 71 to turn the tilt shaft 34 through the driven wheel 60 for easily tilting the slats 321. In addition, when the left and right pulled segments 82,81 stand still, the joined gripped end 83 is disposed forwardly and away from the slats 321 so as to avoid hindrance caused by the slats 321 during the pulling operation of the operating cord 80.

In assembly, the left and right pulled segments 82,81 are brought to extend through the left and right holes 44 to wind the operating cord 80 on the pulley roller 72. Subsequently, the driven wheel 60 and the driving shaft 71 are received in the left concavity half 512 and the left slot half 514 in the left shell half 51 to permit the driven wheel 60 to mesh with the driving shaft 71. The right shell half 52 is complementarily coupled to the left shell half 51 so as to dispose the driven wheel 60 and the driving shaft 71 in the shell 50. Subsequently, the shell 50 and the operating unit 70 are disposed on the mounting seat 40, with the bottom portions 511,521 attached to the base wall 41. A locking pin 90 is then inserted into the left and right locking holes 516,526 and the lugs 43 so as to secure the shell 50 and the operating unit 70 to the mounting seat 40. Finally, the tilt shaft 34 is caused to engage the hole 61 through the left and right through holes 513,523.

As illustrated, since the joined gripped end 83 of the operating cord 80 is disposed forwardly and away from the slats 321, it will not be obstructed by the slats 321 during the pulling operation of the operating cord 80. Therefore, the pulling operation is convenient to conduct. Moreover, the pulley roller 72 is integrally formed with the driving shaft 71, thereby resulting in good transmission efficiency, a longer service life, and reduced costs.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A slat tilting device for a window covering which includes a header rail extending in a longitudinal direction, a plurality of slats disposed beneath the header rail and connected to one another in an upright direction perpendicular to the longitudinal direction by a connecting cord that includes front and rear cord segments respectively disposed forwardly and rearwardly of the slats, and a tilt shaft that is mounted on the header rail and that is turnable relative thereto about a turning axis in the longitudinal direction so as to pull either the front or rear cord segment to thereby tilt the slats, said device comprising:
a mounting seat including
a base wall which is adapted to be fixedly mounted on the header rail, and which has a horizontal surface that extends in the longitudinal direction and that has front and rear end regions opposite to each other in a transverse direction perpendicular to the upright and longitudinal directions, and a middle region disposed between said front and rear end regions, said front end region having left and right holes which extend through said base wall in the upright direction, and
a bearing wall which extends from said middle region in the upright direction and which terminates at a bearing surface;
a journal segment journalled on said bearing surface to be rotatable about a first rotating axis, and having front and rear ends which are opposite to each other in the transverse direction;
a driving shaft connected to said rear end of said journal segment, and extending along the first rotating axis, which extends rearwardly and downwardly toward said horizontal surface;
a pulley roller connected to said front end of said journal segment, and rotatable coaxially with said driving shaft about the first rotating axis;
a driven wheel which is disposed to be driven by said driving shaft to rotate about a second rotating axis, and which is adapted to align the second rotating axis with the turning axis so as to drive the tilt shaft to turn about the turning axis, thereby pulling the front or rear cord segment for tilting the slats; and
an operating cord wound on said pulley roller about the first rotating axis and adapted to be disposed forwardly of the slats, said operating cord having left and right pulled segments which extend downwardly through said left and right holes to terminate at a joined gripped end for manual operation such that pulling of either said left or right pulled segment results in rotation of said pulley roller about the first rotating axis so as to enable said driving shaft to turn the tilt shaft, and such that when said left and right pulled segments stand still, said joined gripped end is disposed forwardly and away from the slats so as to avoid hindrance caused by the slats during the pulling operation of said operating cord.

2. The slat tilting device of claim 1, further comprising:
left and right shell halves which are mounted on and which extend from said base wall in the upright direction, and which are spaced apart from each other in the longitudinal direction, said left and right shell halves having left and right concavity halves which cooperatively receive said driven wheel, and left and right slot halves which cooperatively receive said driving shaft.

3. The slat tilting device of claim 1, wherein said journal segment is integrally formed with said driving shaft and said pulley roller.

4. The slat tilting device of claim 1, wherein said driving shaft and said driven wheel are of a worm-and-worm gear construction.

5. The slat tilting device of claim 1, wherein said bearing wall has an upwardly opening slot which extends downwardly to terminate at said bearing surface so as to journal said journal segment on said bearing surface to thereby permit rotation of said journal segment about the first rotating axis.

6. The slat tilting device of claim 1, wherein the first rotating axis extends to intersect said horizontal surface and form an included angle ranging from about 10 degrees to about 20 degrees therewith.
